(19) United States
(12) Patent Application Publication
(10) Pub. No.: US 2012/0331084 A1
(43) Pub. Date: Dec. 27, 2012

(54) Method and System for Operation of Memory System Having Multiple Storage Devices

(75) Inventors: Cheng-Wei Chang, Sunnyvale, CA (US); William Bjorge, Los Gatos, CA (US)

(73) Assignee: Motorola Mobility, Inc., Libertyville, IL (US)

(21) Appl. No.: 13/344,238

(22) Filed: Jan. 5, 2012

Related U.S. Application Data
(63) Continuation-in-part of application No. 13/168,423, filed on Jun. 24, 2011, now abandoned.

(51) Int. Cl. G06F 15/167; G06F 15/16

(52) U.S. Cl. 709/213

(57) ABSTRACT

Systems and methods for operation of a memory system are disclosed. In some example embodiments, a system for storing or retrieving data in response to one or more signals provided from one or more clients includes a plurality of memcached-type memory devices arranged in a cluster, and a proxy module configured to communicate at least indirectly with each of the memcached-type memory devices and further configured to receive the one or more signals. The proxy module is configured to perform a determination of how to proceed in communicating with the memcached-type memory devices for the purpose of the storing or retrieving of data at or from one or more of the memcached-type memory devices in response to the one or more signals. In additional example embodiments, the proxy module is a centralized proxy and makes selections among the memory devices based upon performing of a memcache selection/fail-over algorithm (MSFOA).

### CROSS-REFERENCE TO RELATED APPLICATIONS

This application is a continuation-in-part of, and claims the benefit of, U.S. utility patent application Ser. No. 13/168,423 filed on Jun. 24, 2011 and entitled “Method and System for Operation of Memory System Having Multiple Storage Devices”, which is hereby incorporated by reference herein.

### STATEMENT REGARDING FEDERALLY SPONSORED RESEARCH OR DEVELOPMENT

--

### FIELD OF THE INVENTION

The present invention relates to storing and retrieving of data and, more particularly, the storing and retrieving of data from memory systems such as, for example, memcached server systems.

### BACKGROUND OF THE INVENTION

Services serving many (e.g., millions) of users require large numbers of computers to operate. Memcached server systems are one type of server system for caching that involves distributed memory provided via multiple servers in one or more server clusters. Memcached uses consistent hashing to handle the failure of any given memcached server in a server cluster. More particularly, each memcache client uses consistent hashing to figure out which memcache device (among many in a cluster) to use for storing/updating/deleting data.

This manner of handling failures is problematic when attempting to provide a consistent view of the data store in the memcached cluster. A request to store data that maps to a given hashing value that corresponds to a given server will go to that server when the server is present. However, if the given server of the cluster is intermittently dropping out of and reentering into the cluster, and if subsequently a read arrives when that given server is not present, then the read will be directed to a different server and fail to read the proper data. Thus, although memcached provides atomic operations on a per server basis, it does not provide consistency for those operations across all servers in a memcached cluster. This can be even more problematic when one recognizes that memcached server clusters not only often span multiple servers but also even multiple data centers, such that scalability and reliability issues become significant.

Memcache clients can be enhanced by adding proprietary health-check infrastructure and ad-hoc algorithms for selecting which memcache device instance to use in addition to the default vanilla “circular hashing” (which can also be referred to as “consistent hashing”). Such an algorithm can be referred to as a “memcache-selection/fail-over algorithm” (MSFOA). However, no matter what MSFOA is used, as long as the decision is made by each individual clients on their own, there will be chances of encountering inconsistencies among different clients, leading to incorrect functioning of applications.

For example, suppose a first client (e.g., client A) wants to store a data item with a key K, so it performs a MSFOA, which results in a decision to use memcache device X for storing item K. In this case, the client A will store the data with key K to memcache device X. Additionally, suppose that a second client (e.g., client B) wants to retrieve data item with key K, so it uses the same MSFOA to figure out that memcache device X should have the desired data. However, upon accessing X, client B suddenly finds that memcache device X does not respond to client B's request within a pre-agreed timeout (e.g., because the network in between X and B happens to have spiky data traffic causing congestion, which persists for several seconds). In such case, per the same proprietary MSFOA, client B needs to revisit the same MSFOA again for appropriate action to take in this situation. Yet, depending on the decision made by the proprietary MSFOA, the process can advance in two different manners: either (a) another memcache device Y is chosen, in which case the client B tries to retrieve data item with key K from the memcache device Y, but finds the data item is absent there, thus claiming data K does not exist at the moment (also it is possible for client B to store a new data item with same key K to memcache device Y); or (b) there is returned an “access error” for the data item with key K—in this case, client B returns “access error” back to the applications. It should further be noted that, in this example, the client A is assumed to be able to access the data item with key K from memcache device X during this whole period of time; however, if data item K is used as a lock, then client A will have mistakenly been assuming it always owns the lock during this whole period of time.

It would therefore be advantageous if an improved method or system could be developed for storing and/or retrieving data that overcame one or more of these limitations in relation to memcached systems and/or one or more other types of memory storage systems.

### SUMMARY OF THE INVENTION

In at least one embodiment, the present invention relates to a system for storing or retrieving data in response to one or more signals provided from one or more client computer devices. The system includes a plurality of memcached-type memory devices arranged in a cluster, and a proxy module configured to communicate at least indirectly with each of the memcached-type memory devices and further configured to receive the one or more signals. The proxy module includes a memory portion that stores information regarding a status of each of the memcached-type memory devices, particularly in terms of whether each of the memcached-type memory devices is in an active state, an inactive state, or a transitional state between the active and inactive states. Also, the proxy module and memcached-type memory devices communicate on an ongoing basis so that the information regarding the status of each of the memcached-type memory devices that is stored in the memory portion is repeatedly updated. Further, the proxy module determines how to proceed in communicating with the memcached-type memory devices for the purpose of the storing or retrieving of the data based at least in part upon the information stored in the memory portion.

Further, in at least one embodiment, the present invention relates to a method of handling a signal from a client computer system, the signal being indicative of a request pertaining to a data item that is included in or referenced by the signal, the request concerning performing of an action in relation to a memory system including a plurality of memcached-type memory devices. The method includes receiving the signal at a proxy module, and determining an initial one of the memcached-type memory devices that should be contacted in relation to the request indicated by the signal based upon a circular-hashing process. The method also includes consulting a memory portion associated with the proxy module to obtain a status indication concerning the initial one of the memcached-type memory devices or another one of the memcached-type memory devices and, if the status indication does not indicate an inactive state, then performing at least one additional determination as to whether the initial one or the other one of the memcached-type memory devices is appropriate for accessing and, if so, causing the performing of the action in relation to the initial one or the other one of the memcached-type memory devices so as to satisfy the request.

Additionally, in at least one embodiment, the present invention relates to a method of operating a memory system including a plurality of memcached-type memory devices to respond to signals from clients indicative of requests to be performed in relation to data items. The method includes providing a proxy module, and sending communications from the proxy module for receipt by each of the respective memcached-type memory devices. The method further includes storing status indications regarding statuses of each of the memcached-type memory devices in a memory portion associated with the proxy module, based upon responses received from the memcached-type memory devices. The method additionally includes receiving the signals at the proxy module, and determining actions to be performed by the proxy module in relation to one or more of the memcached-type memory devices, the actions being determined based at least in part upon the requests, the stored status indications, and time-to-live (TTL) values associated with the data items with respect to which the requests pertain. The method further includes performing the actions in accordance with the determining, wherein the actions involve one or more of: reading one or more of the data items from one or more of the memcached-type memory devices; writing one or more of the data items to one or more of the memcached-type memory devices; causing an updating of one or more of the data items stored in one or more of the memcached-type memory devices; and causing a removal of one or more of the data items from one or more of the memcached-type memory devices.

Additionally, in at least one embodiment, the present invention relates to a system for storing or retrieving data in response to one or more signals provided from one or more client computer devices. The system includes a plurality of memcached-type memory devices arranged in a cluster, and a proxy module configured to communicate at least indirectly with each of the memcached-type memory devices and further configured to receive the one or more signals. The proxy module is configured to perform a determination of how to proceed in communicating with the memcached-type memory devices for the purpose of the storing or retrieving of data at or from one or more of the memcached-type memory devices in response to the one or more signals.

Further, in at least one embodiment, the present invention relates to a method of handling a signal from a client computer system, the signal being indicative of a request pertaining to a data item that is included in or referenced by the signal, the request concerning performing of an action in relation to a memory system including a plurality of memcached-type memory devices. The method includes receiving the signal at a proxy module, and determining an initial one of the memcached-type memory devices that should be contacted in relation to the request indicated by the signal based at least in part upon a consistent-hashing process. The method also includes engaging in at least one communication with the initial one of the memcached-type memory devices in order to store, retrieve, or attempt to retrieve the data item to or from the initial one of the memcached-type memory devices, in order to take an action responsive to the request.

Additionally, in at least one embodiment, the present invention relates to a method of operating a memory system including a plurality of memcached-type memory devices to respond to signals from clients indicative of requests to be performed in relation to data items. The method includes providing a proxy module, receiving the signals at the proxy module, and determining actions to be performed by the proxy module in relation to one or more of the memcached-type memory devices, the actions being determined based at least in part upon the requests. The method also includes performing the actions in accordance with the determining, where the actions involve one or more of: reading or attempting reading of one or more of the data items from one or more of the memcached-type memory devices; writing one or more of the data items to one or more of the memcached-type memory devices; causing an updating of one or more of the data items stored in one or more of the memcached-type memory devices; and causing a removal of one or more of the data items from one or more of the memcached-type memory devices.

### BRIEF DESCRIPTION OF THE DRAWINGS

FIG. 1 is a schematic diagram of an exemplary system for storing or retrieving information in response to signals from one or more client computer devices (two of which are shown), which particularly employs a plurality of memcached-type memory devices in a memory cluster and a proxy device for interfacing with those memory devices;

FIG. 2 is a flow chart illustrating exemplary steps of operation of the proxy device of FIG. 1 in communicating with the memcached-type memory devices and otherwise operating so as to determine operational statuses of those memory devices;

FIG. 3 is flow chart illustrating exemplary steps of operation of the proxy device of FIG. 1 in responding to the signals from the one or more client computer devices, particularly in terms of determining how to access or not access one or more of the memcached-type memory devices based in part upon the operational statuses of those memory devices; and

FIG. 4 is a flow chart illustrating exemplary steps of operation of the proxy device of FIG. 1 in responding to signals from the one or more client computer devices, particularly showing a manner of operation in which a memcache selection/fail-over algorithm (MSFOA) is employed in determining accessing of one or more of the memcached-type memory devices.

### DETAILED DESCRIPTION

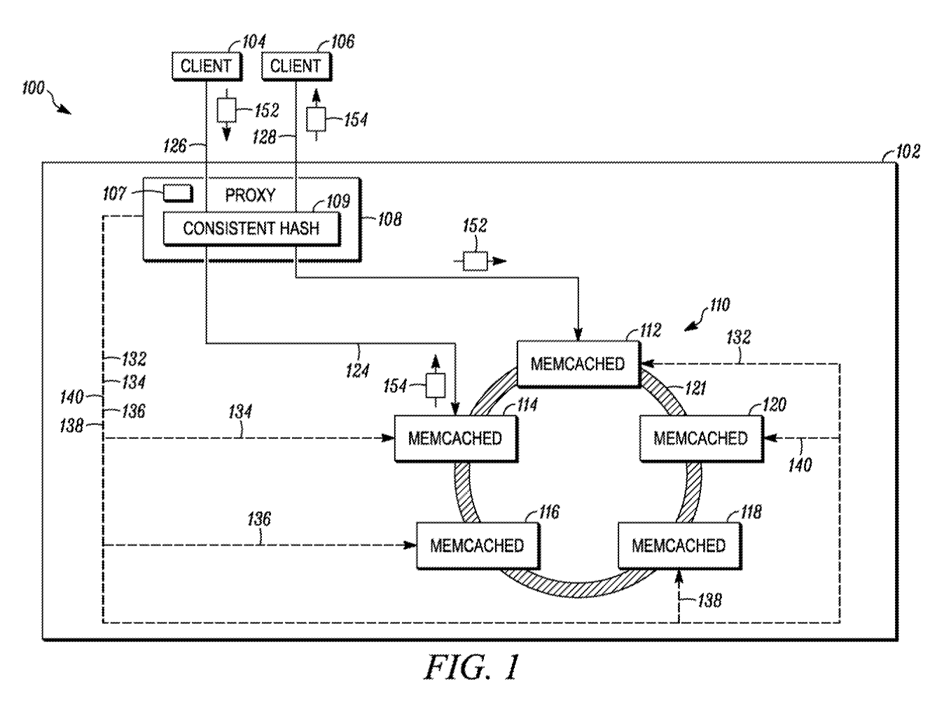

Referring to FIG. 1, a schematic diagram 100 is provided to illustrate an exemplary system for accomplishing, storing and retrieval of information at a memcached storage system 102. In this embodiment, the memcached storage system (or simply memcached system) 102 can be referred to also as a consistent service cluster or simply as a consistent cluster (CC). The schematic diagram 100 further illustrates how multiple clients, in this case an exemplary first client 104 and second client 106, are in contact or communication with the memcached system 102. As shown, the memcached system 102 itself includes a proxy device 108 (or proxy module) that further includes a memory module 107 and a consistent-hashing module 109. It should be noted that, for purposes of the present description, the term “consistent-hashing” is used interchangeably (or at least substantially interchangeably) with the term “circular-hashing”, the two terms referring to identical or substantially identical processes. Also, while both the terms “memcache” and “memcached” are utilized herein somewhat interchangeably and fungibly, and can be understood from the particular contexts herein in which those terms are being used, in general the term “memcache” can be understood as referring to memcache software solutions (including server and client) as a whole, while the term “memcached” can be understood as referring to a memcache server daemon process usually running on a Linux/Unix server box.

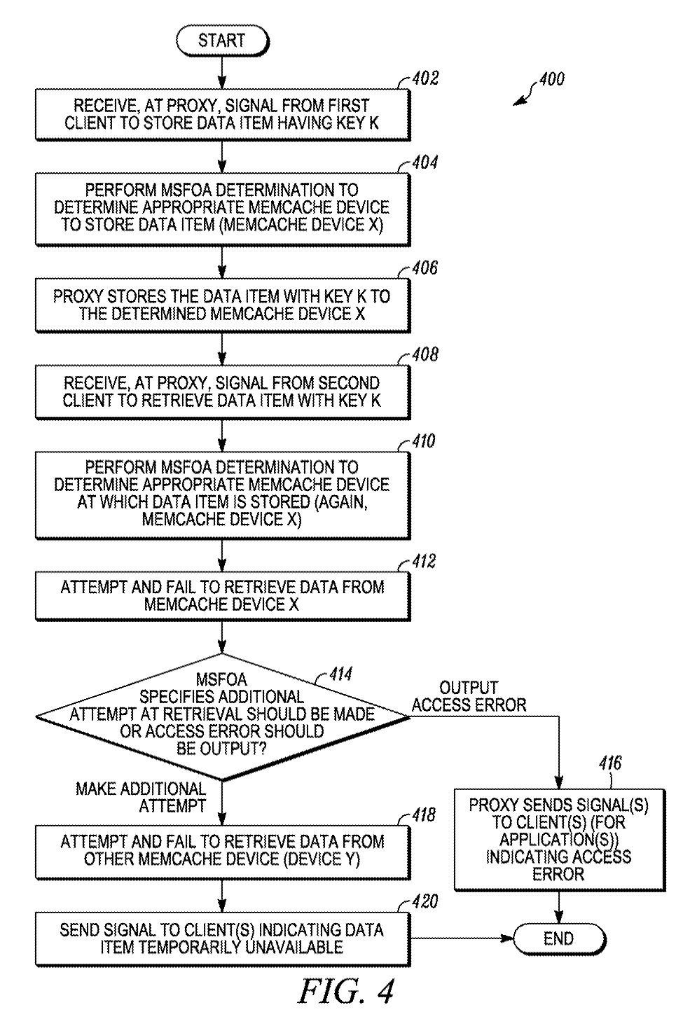

Also as shown in FIG. 1, in at least some embodiments, and as will be discussed particularly with respect to FIG. 4, the proxy device 108 includes a memcache selection/fail-over algorithm (MSFOA) module 160 that can be employed as part of the proxy device 108 to perform any one or more of a variety of memcache selection/fail-over algorithms. Although the proxy device 108, as well as each of the memory module 107 and the consistent-hashing (or circular-hashing) module 109 and the MSFOA module 160, can each be separate discrete devices (e.g., discrete respective microchips, microcontrollers, microprocessors, etc.), one or more of the proxy device and the aforementioned modules can also be software processes executed on one or more processing devices (e.g., on a microprocessor) associated with the memcached system.

Further, the memcached system 102 includes a cluster of memcached servers (or memcached server cluster) 110. Each of the servers can take a variety of forms depending upon the embodiment and, in at least some embodiments, each of the servers is a distinct server computer including one or more associated memory devices. Although the number of memcached servers that are within the memcached server cluster can vary depending upon the embodiment, in the present embodiment, the memcached server cluster 110 includes five memcached servers, namely, a first memcached server 112, a second memcached server 114, a third memcached server 116, a fourth memcached server 118 and a fifth memcached server 120. The memcached servers 112, 114, 116, 118, 120 are schematically shown to be arranged around a ring 121, it being understood that this configuration is merely intended to illustrate how the memcached servers are conceptually arranged within the memcached server cluster for the purpose of allocating resources or ascribing data (particularly by the consistent-hashing module 109), but is not intended to illustrate any particular physical arrangement of the memcached servers.

Further as illustrated in FIG. 1, the proxy device 108 is in communication with the memcached servers 112, 114, 116, 118, 120 in two different manners. First, the consistent-hashing module 109 is capable of communicating with each of the memcached servers 112, 114, 116, 118, 120 for the purpose of storing and retrieving information. In particular, FIG. 1 shows the consistent-hashing module 109 to be in communication with the first memcached server 112 by way of a first link 122 and to be in communication with the second memcached server 114 by way of a second link 124. In at least some embodiments, whether a given one or another of the memcached servers is selected for the purpose of storing and/or retrieving a given portion of information is determined by the consistent-hashing module 109. However, in at least some other embodiments, including the embodiment discussed with respect to FIG. 4, whether a given one or another of the memcached servers is selected for the purpose of storing and/or retrieving a given portion of information is determined by the consistent hashing module 109 in combination with the MSFOA module 160. Although only the links 122 and 124 are shown, it should be understood that the proxy device 108 can also be in communication with any of the other memcached servers 116, 118 and 120 by way of additional links (not shown).

In addition to being in communication with the memcached servers 112, 114, 116, 118, 120 via the links 122, 124 (and other such links not shown) for the purpose of storing and retrieving information, in the present embodiment the proxy device 108 is also in communication with each of the memcached servers 112, 114, 116, 118, 120 for the purpose of status monitoring. Thus, as shown, the proxy device 108 is in communication with each of the first, second, third, fourth, and fifth memcached servers 112, 114, 116, 118, 120, respectively, by way of first, second, third, fourth, and fifth status monitoring links 132, 134, 136, 138 and 140, respectively (for simplicity of illustration, two or more of these links are represented in combination by a single dashed line along certain portions of the path between the proxy device 108 and the respective memcached servers in FIG. 1. It should be noted that, while the present embodiment shows a single proxy device and no load balancer, in other embodiments, there can be multiple proxies and/or one or more load balancers.

Further as shown in FIG. 1, the proxy device 108 is able to communicate with multiple clients. As already noted, in the present example, the first client 104 and second client 106 particularly are shown to be in communication with the proxy device 108, by way of a first communication link 126 and a second communication link 128, respectively. The communication links 126, 128 can each include one or more wired or wireless communication links depending upon the embodiment. The number of communication links between such clients and the proxy 108 can be the same as the number of clients themselves, although this also can vary depending upon the embodiment. By virtue of the communication links 126, 128, the first and second clients are able to send any of a variety of requests and/or commands to the memcached system 102. More particularly, these requests and/or commands can include signals to read (retrieve), write (store), update, and/or remove pieces of information or data elements in relation to the memcached system 102 (and particularly to the memcached server cluster 110).

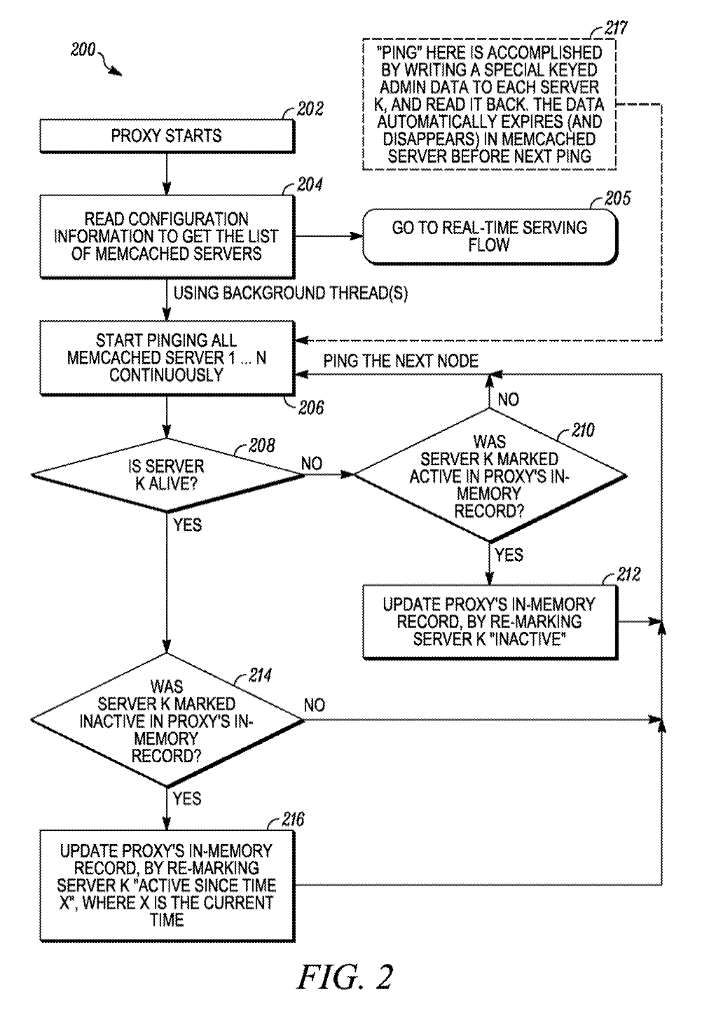

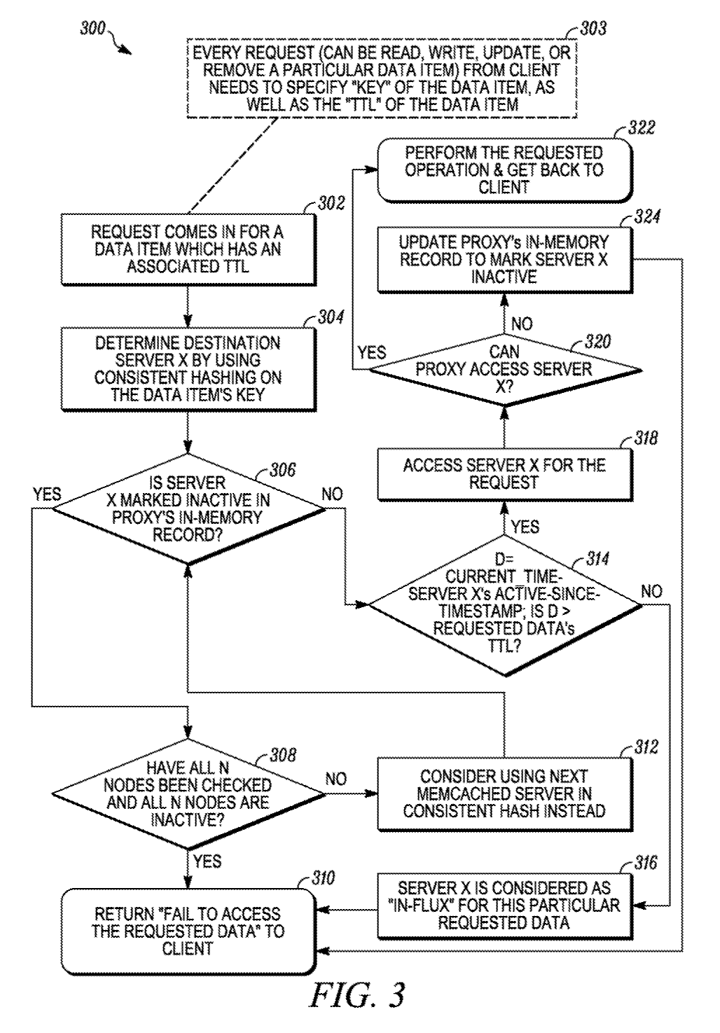

Upon being received by the proxy device 108, the proxy device handles the requests/commands provided by these signals and, in particular, causes writing (storing), updating, reading (retrieving), and removing options to be performed in relation to appropriate one(s) of the memcached servers 112, 114, 116, 118, 120. For example, as illustrated in FIG. 1, when a write command is issued by the first client computer 104, a first data item 152 can be sent to the proxy device 108 and, in response, the first data item can be (based upon operation of the proxy device, as discussed more fully below with reference to FIGS. 2 and 3), sent to one (or possibly more than one) of the memcached servers 112, 114, 116, 118, 120 such as, in this example, the first memcached server 112. Also for example, as illustrated in FIG. 1, when a write command is issued by the second client computer 106, a second data item 154 can be retrieved by the proxy device 108 (based upon the operation of the proxy device, as discussed more fully below) from one (or possibly more than one) of the memcached servers 112, 114, 116, 118, 120 such as, in this example, the third memcached server 116. Upon retrieving the second data item 154, the proxy device 108 can then pass along the second data item back to the second client 106 as also shown in FIG. 1.

Turning to FIGS. 2 and 3, first and second flowcharts 200 and 300 are respectively provided that illustrate exemplary steps of operation of the memcached system 102 shown in FIG. 1. The flowchart 200 of FIG. 2 particularly illustrates how the memcached system 102 operates in terms of monitoring the status of the various memcached servers 112, 114, 116, 118, 120 by way of the operation of the proxy device 108 communicating with those servers via the communication links 132, 134, 136, 138, 140. By comparison, the flowchart 300 of FIG. 3 shows how the proxy device 108 operates to intercommunicate with the memcached servers 112, 114, 116, 118, 120 for the purpose of reading (retrieving), writing (sending), updating, or removing information/data items in relation to those servers, while taking into account status information as developed by way of the process of the flowchart 200 of FIG. 2. As described further below, it should be understood that the processes represented by the flowcharts 200 and 300 (or at least portions thereof) are typically both performed simultaneously in an ongoing manner, although in alternate embodiments it is possible that the process corresponding to the flowchart 200 (or a portion thereof) could be performed sequentially in relation to the process corresponding to the flowchart 300 (or a portion thereof), including with the various processes (or process portions) being performed repeatedly sequentially in an alternating manner.

Particularly referring to FIG. 2, the flowchart 200 begins at a first step 202 in which the proxy device 108 starts operation. Once the proxy device 108 is operating, then as indicated by a subsequent step 204 the proxy device reads configuration information to obtain the list of memcached servers, for example, the memcached servers 112, 114, 116, 118, 120 of FIG. 1 (the list can also be a list of memcached server nodes rather than simply memcached servers). Upon reading this information, as indicated by a step 205, the proxy device 108 enters into a real-time serving flow that is ongoing. This serving flow can be particularly considered to include the process represented by the flow chart 300 of FIG. 3. Further, simultaneous with the execution of the step 205, a series of additional steps are performed by the memcached system 102 as well, namely a series of steps 206-216 as described further below.

More particularly in this regard, at a step 206, the proxy device 108 pings all of the memcached servers (or server nodes) 1-N continuously. In the exemplary memcached system 102 of FIG. 1, the proxy device 108 pings all of the memcached servers 112, 114, 116, 118, 120. These pinging actions can be communicated by way of the communication links between the proxy device 108 and the memcached servers such as, for example with respect to FIG. 1, the links 132, 134, 136, 138, 140. As illustrated in a block 217, the pinging signal interaction in the present embodiment is accomplished by writing a special key administration data to each of the memcached servers (or server nodes) 112, 114, 116, 118, 120 (e.g., each Kth one of the N memcached servers) and reading that back. The data automatically expires (and disappears) from the memcached servers (or server nodes) 112, 114, 116, 118, 120 before the next ping occurs.

As represented by a step 208, in response to the proxy device 108 pinging the various ones of the memcached servers 112, 114, 116, 118, 120, the proxy device then receives responses (or fails to receive responses) from those servers and, based upon those responses (or absence of responses), determines if each respective one of the servers is alive (each Kth server). If it is determined that a given one of the memcached servers 112, 114, 116, 118, 120 is inactive (not alive/operational), then the process advances to a step 210 at which the proxy device 108 further determines whether the proxy device's records in the memory module 107 show that server K as being marked inactive or active. If as determined at the step 210 the server K is marked active in the proxy's memory module 107, then the process advances to a step 212 in which the proxy device's in-memory record is updated, particularly to state that the server K is inactive (not alive/operational) any longer. Upon completion of the step 212, or in the case where at the step 210 it is determined that the server K was not marked as active (properly so) in the memory module 107, then in each of these cases the process returns to the step 206 so that the next one of the memcached servers 112, 114, 116, 118, 120 (e.g., the (K+1)th server or, if all servers have already been checked, then the 1^{st} server again) is pinged.

Additionally, if at the step 208 it is determined that the pinged server K is alive, then the process instead of going to the step 210 instead proceeds to a step 214, at which it is determined by the proxy device 108 whether the server K was marked inactive (or not alive) in the proxy's memory module 107. If the node K was not improperly marked inactive, then the process again returns to the step 206 at which still the next memcached server is pinged (again, e.g., the (K+1)th server or, if all servers have already been pinged, then the 1^{st} server again). Alternatively, if at the step 214 it is determined that the server K was improperly marked inactive in the proxy device's memory module 107, then the process advances to a step 216, at which the proxy device's memory module is again updated. In this case, the updating involves marking (or revising) the record in the memory module 107 concerning the server K of interest to note that the server K is alive (active) since a time X, where X is the current time when the updating of the record occurs. The process then returns again to the step 206.

As already noted, the pinging of the memcached servers 1 to N continues indefinitely. More particularly, when all of the N servers have been pinged, then the process is repeated beginning with the first of the servers, and thus all of the servers (or server nodes) are sequentially pinged again and again. Typically the order of pinging is in accordance with the ordering of the memcached servers within the memcached server cluster. Thus, for example with respect to the memcached system 102 of FIG. 1, the pinging by the proxy device 108 can successively involve the pinging of each of the first, second, third, fourth, and fifth memcached servers 112, 114, 116, 118, and 120, respectively, successively in order around the ring 121, and upon completing the pinging of the fifth memcached server the proxy device 108 can then jump back to ping the first memcached server such that the process is repeated.

Turning now to FIG. 3, exemplary operation of the memcached system 102 in terms of reading or writing (or updating or removing) data with respect to the various memcached servers 112, 114, 116, 118, 120 is shown in the form of the flow chart 300. As mentioned, such operations can be, and typically are, performed simultaneously with operations associated with the flow chart 200 (e.g., the operations of the flow chart 300 can be considered to correspond to the performing of the step 205 of FIG. 2, which is performed simultaneously with the steps 206-216 of that flow chart). That said, the process of FIG. 3 begins with a step 302, at which a request is received at the proxy device 108 from one of the clients (e.g., from one of the first client 104 or second client 106 by way of a corresponding one of the communication links 126 or 128, respectively) of FIG. 1 relating to a particular data item such as one of the data items 152 or 154 shown in FIG. 1. As indicated by a dash block 303 of FIG. 3, every such request (which again can be a request to read, write, update, or remove a particular data item) from a client such as the clients 104, 106 in the present embodiment is assumed to specify a “key” of the data item as well as a time to live (TTL) of the data item. In the present embodiment, it is assumed that each request specifies a TTL for the data item and that the specified TTL is consistent for that particular data item no matter which client (or application server) issues the request, although in alternate embodiments other assumptions can be made.

Upon such a request coming in at the step 302, the process next advances to a step 304, at which the proxy device 108 determines a destination server X for that request based upon a consistent-hashing (or circular-hashing) associated with the data item's key. That is, the proxy device 108 determines which of the memcached servers among the memcached server cluster (e.g., which of the servers 112, 114, 116, 118, 120 of the cluster 121 of FIG. 1) is the appropriate target of the request given the key of the data item with which the proxy device is associated. The circular-hashing can be determined (in other words, the circular-hashing process can be performed) by the consistent-hashing (or circular-hashing) module 109 of FIG. 1. Upon determining the appropriate one of the memcached servers that should be targeted, the process of FIG. 3 then further advances to a step 306, at which the proxy device 108 determines whether the server X is marked inactive in the proxy device's memory module 107 or is marked as having some other status (e.g., active). As explained already with respect to FIG. 2, the proxy device's memory module 107 is being constantly updated with additional status information based upon its continuous monitoring of the memcached servers of the memcached server cluster.

If at the step 306, the server X is marked inactive, then the process next turns to a step 308, in which the proxy device 108 further determines whether all of the available memcached servers (all N servers, of which server X is but one) have been checked and all of those servers are inactive. If this is the case, then the process advances to a step 310 at which the proxy device 108 returns to the requesting client (that is, the client from which the request was received at the step 302) a “failed to access requested data” response or similar response indicative of a failure or inability to accomplish the requested task. If however at the step 308 it is determined that not all of the N servers have been checked (or that one or more of the N servers are active), then the process instead proceeds from the step 308 to a step 312, at which the proxy device 108 considers using another memcached server. In the present embodiment, the next one of the memcached servers determined at the step 312 can be determined using a consistent hash algorithm.

Upon performing the step 312, the process returns to the step 306, at which the proxy device 108 again considers whether the server X (as determined at the step 312) is marked inactive in the proxy device's memory module 107. If this is the case again, then the process already discussed involving steps 308 and 310 or 312 repeats itself by advancing to the step 308. However, if it is not the case and the server X is not marked inactive, then instead the process advances to a step 314.

At the step 314, the proxy device 108 determines a value D as equaling the current time minus the active-since time stamp of the server X (the server node under consideration) and determines whether the value D is greater than the TTL value of the data item with respect to which the request received at the step 302 pertained. The active-since time stamp of the server X is the time at which the server X first became active (operational). If at the step 314 it is determined that the D value calculated is not greater than the TTL of the data item to which the request pertained, then the process advances to a step 316, at which the proxy device 108 determines that the server X is considered to be “in flux” for this particular requested data, and subsequently the process returns to the step 310 at which a failure message (as described earlier) is returned back to the originally-requesting client.

However, if alternatively at the step 314 it is determined that the value for D is greater than the TTL of the data item to which the request pertained, then the process instead advances to a step 318, at which the proxy device 108 accesses the server X to perform the requested operation in relation to the data item of interest. Additionally, upon the completion of the step 318 the proxy device 108 further determines whether it is successfully accessing the server X. If the answer is yes, then the process at a step 322 performs the requested operation in relation to the data item to which the request of the step 302 pertained and the information is then returned back to the requesting client. Also, the operation can be a write, read, update, or remove operation. However, if at the step 320 it is determined that the proxy device 108 is not able to access the server X to obtain the requested information or otherwise perform the requested operation, then the process advances to update the proxy device's memory module 107 to mark the server X inactive at a step 324 and the process again proceeds to the step 310 at which it sends a failure message to the client.

As already mentioned in relation to FIG. 1, in at least some embodiments, the proxy module 108 includes not only the consistent hash module 109 but also the memcache-selection/fail-over algorithm (MSFOA) module 160 by which MSFOA calculations or determinations are performed. In such embodiments, the proxy device 108 determines which one or more of the memcached servers 112, 114, 116, 118, 120 should be contacted for the purpose of storing or retrieving given data items such as the data items 152, 154 based at least in part upon the MSFOA calculations/determinations of the MSFOA module 160. Depending upon the embodiment or implementation, the MSFOA module 160 determinations can exclusively determine the appropriate memcached servers to be contacted for storing or retrieving data items, or alternatively the appropriate memcached servers to be contacted can be determined based in part upon the MSFOA module determinations and in part upon other determinations or sources of information including, for example, determinations by the consistent hash module 109.

In the present embodiments, the proxy device 108 operates as a centralized proxy in that all of the communications between all of the clients (in this example, the clients 104 and 106) and all of the memcached servers 112, 114, 116, 118, 120 of the cluster 110. In alternate embodiments, it is possible that the proxy device 108 can operate substantially as a centralized proxy, at least with respect to a given set of other devices, by handling all communications between a given set of clients (even if not encompassing all possible clients) and/or a given set of memcached servers (even if not encompassing all possible memcached servers). The proxy device 108, operating as a centralized proxy, serves to detect health or status characteristics of the memcache devices (that is, of all of the memcached servers 112, 114, 116, 118, 120), and to perform MSFOA determinations or other determinations that govern the actual data accessing (storage and retrieval operations) with respect to the memcache devices.

Such embodiments employing the MSFOA module 160 can be particularly advantageous in that, in at least some embodiments, such embodiments make it possible to avoid or minimize inconsistencies between clients. More particularly in this regard, it is desirable that proxy device 108 operate in such a manner that storing and retrieving of each given one of the data items 152, 154 with respect to the various memcached servers 112, 114, 116, 118, 120 occur in the same manner regardless of which of the clients 104, 106 has sent a request or command to store or retrieve the data item. That is, the operations of storing and/or retrieving each respective one of the data items 152, 154 with respect to the cluster 102 should appear to be identical for each of the clients 104, 106 that are requesting such storing and retrieving, regardless of which of the clients is/are making such requests.

Referring particularly to FIG. 4, an additional flow chart 400 is provided that shows exemplary operation of the memcached system 102 having the MSFOA module 160, in terms of retrieving or storing (or reading or writing, or updating or removing) data with respect to the various memcached servers 112, 114, 116, 118, 120 in response to received requests/commands from the first and second clients 104 and 106 of FIG. 1. It should be appreciated that the process of FIG. 4, while particularly described as pertaining to the memcached system 102 and the clients 104, 106 is intended to be applicable with respect to a variety of other memcached systems, including memcached systems having other numbers of memcached servers than five memcached servers as shown in FIG. 1, as well as applicable to embodiments or operational circumstances in which there are more than two clients making requests/commands in relation to the memcached system 102.

As shown, upon beginning at a start step, the process represented by the flow chart 400 begins at a step 402 at which the first client 104 (or alternatively some other client, e.g., a client A) decides to store a data item with a key K, which for example can be the first data item 152, such that a signal is sent by the first client to the memcached system 102 and received by the proxy device 108 of the memcached system. Upon the signal being received, at a next step 404 the proxy device 108 performs a MSFOA determination by way of the MSFOA module 160 to determine an appropriate one (or possibly more) of the memcached servers 112, 114, 116, 118, 120, which can be referred to as a memcache device X, at which the first data item 152 should be stored. For example, the memcache device X in one circumstance can be the first memcached server 112. As already noted above, although in some embodiments the MSFOA determination is entirely dispositive in that the MSFOA determination alone determines which of the memcached servers 112, 114, 116, 118, 120 is appropriate to serve as the memcache device X, in other embodiments the determination of the identity of the memcache device X is based in part upon the MSFOA determination and also upon some other determination or source of information, including for example an additional determination or calculation by the consistent hash module 109.

Following the step 404, at a step 406, the proxy device 108 communicates with the memcache device X as determined at the step 404 and in particular sends signal(s) to that memcache device causing storing of the first data item 152 (having the key K) at that memcache device. This storing of the first data item 152 can be understood as being done on behalf of the first client 104 from which the storing command was received at the step 402.

Next at a step 408, the proxy device 108 receives an additional signal sent by the second client device 106 (or some other client device differing from the client device of the step 402), indicating that this client device wants to retrieve the same data item having the key K, which for example can again be the first data item 152. Upon receiving this additional signal, at a step 410 the MSFOA module 160 of the proxy device 108 performs an additional MSFOA determination using the same MSFOA as was used during the step 404, which again results in a determination that the same memcache device X (e.g., in this example, the first memcached server 112) is the memcache device at which the requested data item (the data item 152) is stored and available.

It should be appreciated that, at this point under normal operation, the first data item 152 would be accessed from the memcache device X and then returned by the proxy device 108 to the second client device 106 that made the request at the step 408. However, the flow chart 400 particularly is focused upon an alternate operational scenario in which there is an abnormality such that, upon the proxy device 108 retrieving data from the memcache device X (or attempting to retrieve the first data item 152), the proxy device suddenly finds that the memcache device X is temporarily inaccessible by the proxy device. This can occur for any of a number of reasons including, for example, because a network connection (e.g., the communication link 122) linking the memcache device X and the proxy device happens to have spiky data traffic causing congestion. In such circumstances, an attempt by the proxy device 108 to retrieve the first (requested) data item 152 will fail as shown at a step 412.

In the present embodiment, further as shown in the flow chart 400, when such a failure occurs as indicated by the step 412, then at a step 414 the MSFOA module 160 of the proxy device 108 performs the same (often proprietary) MSFOA as was performed in the steps 404 and 410, to make an additional determination about how to proceed (that is, the proxy device needs to revisit the same MSFOA again for appropriate action to take in this situation). As indicated at the step 414, the MSFOA either (depending upon the embodiment or circumstance) will specify that an additional attempt at retrieval of the first data item 152 should be made or an access error should be output. As shown, if the MSFOA specifies that an access output error should be sent out, then the process advances to a step 416, at which the proxy device 108 sends one or more signals to one or more of the clients, and particularly to the client (in this case, the second client 106) that made the request at the step 408, that there has been an error in attempting to access and retrieve the requested data item (again, in this case, the first data item 152). Such signal(s) (or signal(s) based thereon) can further be then forwarded on by the client(s) to any appropriate application(s), such as an application that had requested that first data item 152 that prompted the second client 106 to make the request at the step 408. Upon the access error signal being sent at the step 416, the process represented by the flow chart 400 then ends, albeit it will be understood that the process can be repeated over and over again with respect to ongoing additional requests made by any of the clients and/or with respect to the first data item 152 or other data items.

Alternatively, if the MSFOA is configured such that, at the step 414, the MSFOA specifies that an additional attempt at retrieval of the first data item 152 should be made, the process instead advances to a step 418. More particularly, at the step 418, the proxy device 108 attempts to retrieve the first data item 152 (that is, the data item with key K) from a different one (or more) of the memcached servers 112, 114, 116, 118, 120 than was attempted to be contacted at the step 412, which can be referred to as a memcache device Y, and for example can be the second memcached server 114. The determination of which of the memcached servers 112, 114, 116, 118, 120 can be based entirely or in part upon a new MSFOA determination or calculation (which can be the same as, or different from, the determinations or calculations made at the steps 404 and 410). In some circumstances, the determination can be based both upon a determination of the MSFOA module 160 and an additional determination of the consistent hash module 109 (or some other determination or information).

It is possible that, upon making the additional attempt at retrieval of the first data item 152, the data item will be successfully retrieved (in which case it will be forwarded by the proxy device 108 to the requesting client 106). However, the process represented by the flow chart 400 is focused upon a circumstance in which the attempt at the step 418 again is a failure. As shown, upon such an failed attempt occurring, and the proxy device 108 finding that the first data item 106 is absent from the memcache device Y, the proxy device 108 sends one or more signal(s) to one or more of the clients, and particularly the client (in this example, the second client 106) that made the request at the step 408, informing the client(s) that the first data item 106 is unavailable (or temporarily unavailable). Thus, the client(s) receiving such signal(s), and particularly the second client 106, recognizes and claims that the requested data item 152 (the data item with the key K) does not exist at the moment (and in some cases can forward this information on to one or more application(s)), at which point the process of the flow chart 400 ends. Again, it should be noted that upon the process ending in this manner, the process represented by the flow chart 400 can be repeated over and over again with respect to ongoing additional requests made by any of the clients and/or with respect to the first data item 152 or other data items.

In addition to the above, it will be appreciated from the above description regarding the above example behavior, since neither the first client 106 nor the second client 108 can directly access any of the memcached servers 112, 114, 116, 118, 120 by itself, it is up to the proxy device 108 to determine which of the memcached servers should be contacted in relation to the storage and retrieval of any given data items. In the present embodiment, after the proxy device finds that the memcache device X (in the present example, the first memcached server 112) is inaccessible when it tries to retrieve the first data item 152 (the data item with key K) on behalf of the second client 106 making the request at the step 408, any attempt to access that data item with key K by any (every) client (including each of the first and second clients 104 and 106) will consistently either use the memcache device Y determined at the step 414 or return an “access error”. So if the first data item 152 (which again in this example constitutes the data item with key K) is used as a lock, there is no way for the first client 104 (which caused storing of that data item in the cluster 102) to mistakenly think it still owns the lock.

Therefore, in at least some embodiments such as that described with respect to FIG. 4, a significant characteristic of the memcached system 102 (and/or the combined system including both the memcached system and the clients with which it interacts) is that, as long as there is a centralized proxy performing MSFOA determinations as well as actual data retrievals, different clients cannot get different outcomes in terms of detecting which memcache device instances are in good or bad health. Thus, regardless of what particular MSFOA algorithm is used to sustain the memcache cluster high availability (HA) promise, the same consistent outcome of executing the algorithm is (and typically must be) received by all different clients. Further, the centralized proxy eliminates the possibility of letting two different memcache devices (e.g., X and Y, or further for example the memcache devices 112 and 114) being chosen by different clients (e.g., the first and second clients 104 and 106) as a result of the MSFOA being executed by individual clients, which can have different views of the states of memcached devices. The MSFOA is executed solely by the MSFOA module 160 that is part of (or associated with) the single proxy device 108, rather than on an ad hoc or individualized basis by the various client devices, and thus the MSFOA is executed in a consistent manner with respect to all of the various clients that interface that proxy device and all of the data items with respect to which those various clients are communicating with the proxy device.

In view of the above discussion, it should be apparent that at least some embodiments encompassed herein make use of a memcached proxy, with specific properties to front for the memcached cluster, so as to provide the consistent cluster (CC) that encompasses both the memcached cluster and the proxy (e.g., the memcached system 102 of FIG. 1). In at least some such embodiments, every data element stored in the CC is assigned a timeout (or TTL) that describes how long that element is valid. Further, in at least some embodiments, different data elements or different types or classes of data elements can have different timeouts, and the algorithm can be made to work with an arbitrary number of these, simply by providing multiple instances of the algorithm for each data element or type/class of data elements (it should be understood that a class of data elements can have only one item in it). Thus, as discussed above, in at least some embodiments the TTL is consistent for a particular data element no matter which clients (e.g., application servers) issue the request. However, this need not be the case in all embodiments.

Indeed, in some other embodiments, each data item identifies itself to the proxy as to which class it belongs to, and the proxy determines if the memcached server or server node is considered to be in a transitional or “in-flux” state, as distinguished from two other active and inactive states, for that particular class of data items. When a memcache device is in the in-flux state, data access is denied (e.g., data items stored in that memcached device are not accessible). In at least some such other embodiments, one will have a collection of different classes for different TTL values (this is typically not as flexible or fine-grained enough for different data items per their desired TTL values). In that approach, there will be a finite number of such different classes, each dedicated for a different TTL range. A data item with a TTL value falling in between two different classes need to be forced to use the class of larger TTL (this will typically make the data item inaccessible for longer period of time). Also, in at least some such other embodiments, the in-flux state can be a “relative” state, depending on each individual data item's TTL value—a memcache device is perceived as in in-flux state if an intended data item's TTL is smaller than the difference value of “current_time−active_since_time”, otherwise, the memcache device is not deemed in the in-flux state. This improvement makes the “classes” or “knobs” infinitely fine-grained.

Additionally, in at least some such embodiments, the proxy that fronts for the memcached servers that are part of the CC keeps track of which memcached servers it considers active (alive, reachable, up, etc), as well as keeps track of the timeout(s) that describes how long the data elements are valid. Each of the memcached servers can be in one of three states, from the point of view of the proxy: active (reachable and able to handle requests), inactive (not reachable or not able to handle requests), and in-flux (a transitional state between active and inactive). All data elements stored in the CC are stored via the proxy. When an element is stored via the proxy, it is mapped to a memcached server via the consistent-hashing (or circular-hashing) module. Then the following happens: (a) if no servers are active, the request is rejected and an error indicating the rejection is returned to the client; (b) if the memcached server to which the request maps is active, the request proceeds to (and is handled by) that server; (c) if the memcached server to which the request maps is inactive, the request is implicitly mapped to the next server to the right (as per regular memcached failover) and these rules are applied again; and (d) if the memcached server to which the request maps is in-flux, the request is rejected and an error indicating that rejection is returned to the client. This way, a request makes its way around the servers in the ring until it succeeds, landing on a server, or is rejected.

As discussed above, in at least some embodiments, the proxy monitors and determines whether or not individual memcached servers in the CC are available for serving requests. This can be done on an ongoing and/or repeated basis, in the background by monitoring the health of the memcached servers. Also, monitoring/determinations by the proxy can be performed on demand, for example, when a request comes in from a client, or by detecting direct data access failures. Also, the proxy module memory can be used to store/remember the health states of each of the memcache devices detected either by any of these methods (e.g., monitoring or by direct data access failure), where this can be accomplished in a variety of manners (e.g., by using separate threads, writing some admin-typed data with small TTL & reading back, etc).

In at least some embodiments, when the proxy determines that an active server has become unavailable (either through monitoring, or because an active request fails), that memcached server is marked (depending upon the embodiment) either as inactive (not alive) or as in-flux. In embodiments where such a memcached server is marked as in-flux, the memcached server remains in the in-flux state for the timeout associated with how long the data elements are valid. At the end of a timeout the proxy either marks the server as active again or marks it inactive, depending upon whether or not the proxy considers the memcached server available. Also, in at least some such embodiments, when the proxy determines that a memcached server which was unavailable is now available, it also marks it (that server) as in-flux. If the memcached server is still available at the end of a period associated with how long the data elements are valid (the timeout), the memcached server is promoted to active status; if not, the server is demoted to inactive.

Also in at least some embodiments, when a CC is started the proxy determines all the available servers in its cluster. In at least some such embodiments, the proxy determines the active/inactive status of each of the servers based upon the results of pinging those servers as discussed above in relation to FIG. 2. Also, in at least some other embodiments, the proxy initially marks all of the servers as in-flux and handles them according to the rule above regarding the unavailable-available transition. Additionally, if at a later time (after operation of the CC has begun) a new server is added to the ring of servers within the CC, the consistent-hashing is updated (e.g., by the consistent-hashing module of the proxy), and all of the servers whose mapping were effected are marked as in-flux. It should be noted in this regard that, although subdividing a given section of the ring is relatively easy, an even redistribution of keys can result in the entire ring not being available. In such circumstances, appropriate selection of what intervals to change (and when) can reduce the impact of something of this nature.

From the above description, it should be appreciated that a variety of embodiments and implementations are encompassed herein, and not merely those specifically discussed above. Among other things, it should be understood that, in at least some embodiments, use of the CC such as described above can allow for locking and consistent data (e.g., course grain locking) on top of the CC. More particularly in this regard, it can be assumed that a primitive has been built on top of a single instance memcached cluster that provides a lock. The lock provides two operations: lock and unlock. When the lock operation succeeds, the client holds the lock until some interval expires, or until they call unlock, whichever comes first. The name of the lock is resolved to some key in the consistent-hash. The interval of the lock is valid and corresponds to the CC element timeout. In practice, the lock timeout typically should be shorter than the element timeout to avoid unintentional races, as the timeout of the lock is also stored in memcached, and becomes invalid when it times out.

Given such an embodiment, under normal operation, the lock name resolves to some particular server (e.g., server A) and consequently lock and unlock operations all hit that server. If server A fails however, then the following occur: (a) until the timeout expires, any client attempting to acquire the lock will fail as server A is considered to be influx; (b) a client already holding the lock is guaranteed to be able to hold it until such time as its timeout expires, because nobody else (e.g., no other client) will be able to grab it in that interval, and it won't have failed over; (c) if no client holds the lock when server A fails, it simply appears as though some other client was in fact holding it, and it is not possible to generate inconsistent data; and (d) if server A remains inactive when the element timeout expires, then the lock now resides on a different server (server B) and is now available, and if server A recovers, then it continues to be the host for that lock and that lock is again available. It should be noted that the unlock operation described above is purely advisory, and is an optimization. As long as the lock operation succeeds, then mutual exclusivity is guaranteed.

Additionally, notwithstanding the above description in which a single proxy device (or proxy) is employed in the CC, for resiliency and scalability, it can be desirable in at least some embodiments for the CC to have multiple proxies rather than merely a single proxy. For multiple proxies to be employed, all that is required is that the multiple proxies maintain a consistent view of the states of the memcached servers that are part of their CC. The rate at which this consistency is maintained will directly affect the element timeout above. In at least some embodiments, the CC is to be placed behind a load balancer, which detects the fail-over of proxies, as well as spreads load among them. Also, in at least some embodiments, the multiple proxies make use of a distributed consistency algorithm (e.g., PAXOS) to maintain a consistent view as to which memcached servers are active, influx or active.

Although the above description particularly concerns the use of consistent hashing, other types or variations of hashing can be employed instead. This can be the case, for example, where other types of memory other than memcached are employed. For example, in some other embodiments, circular-hashing can be utilized (e.g., if a Cassandra data storage system is used). Also, it should be appreciated that various steps or manners of performing operations as discussed above can vary depending upon the type of hashing used. For example, if circular-hashing is employed, the consideration of which memcached server can be next used at the step 312 can be determined by the formula X=(X+1) MOD N, where N is the total number of available memcached servers in the ring.

Also, it should be appreciated that, for purposes of the above description regarding MSFOAs and the MSFOA module 160, the term MSFOA as used herein is specifically intended to exclude consistent hashing (and circular hashing) algorithms and the MSFOA module 160 is understood to not be performing or handling any such algorithms. To the extent a process such as that of FIG. 4 performs any consistent hashing, this is distinct from the performing of any MSFOA, and is performed by another module (e.g., the consistent hashing module 109) rather than the MSFOA module 160. More particularly, the concept of a MSFOA as discussed above is particularly intended to encompass proprietary algorithms, while consistent hashing (or circular hashing) is understood to be a standard (“vanilla”) algorithm that is well-known and used by the public (and typically open-source). Additionally, the term MSFOA as discussed above and used herein is also specifically intended to exclude any time-based algorithm that itself utilizes data items' time-to-live (TTL) values (or time-out(s) in relation to those TTL values) to determine memcache devices' states. In this regard, it should be appreciated that processes employing TTL values are appropriate in embodiments in which each data item has a TTL associated with it; however, in general it is not necessarily the case in all embodiments that each (or any) data items have TTLs). For this reason, embodiments such as that shown in FIG. 4 employing MSFOAs can provide a more generally-applicable solution than embodiments utilizing TTLs such as that of FIG. 3.

In view of these considerations, unless expressly stated to the contrary, it should be understood that the term MSFOA as used herein is particularly intended to exclude consistent (and circular) hashing and is further particularly intended to pertain to any of a variety of proprietary MSFOAs except for any MSFOAs that utilize TTL values or are otherwise based upon times related to data items. For example, the steps of the flow chart 400 of FIG. 4 that refer to performing a MSFOA determination (e.g., the step 404 and the step 410) particularly refer to the performing of proprietary algorithm determinations that do not involve consistent (or circular) hashing and that do not employ TTL values. Even so, given this understanding of the interpretation of the term MSFOA as used herein, it should also be appreciated that any performing of a MSFOA determination can be performed as step distinct and apart from one or more additional steps that can themselves employ consistent hashing and/or TTL value. Relatedly, although the operation of the MSFOA module 160 discussed herein does not include any function employing consistent hashing and/or TTL values, such functions can be employed by other modules such as the consistent-hashing module 109 that perform such functions in a manner that is distinct from the performing of MSFOAs. Further, while the embodiment of FIG. 1 shows the MSFOA module 160 as being distinct from the consistent hashing module 109, in other embodiments it is possible that both the performing of MSFOA(s) and consistent-hashing methods and/or methods utilizing TTL values can all be performed by a single module, albeit even in such embodiments the performing of the MSFOA function will be distinct from the performing of consistent hashing or functions employing TTL values.

Finally, notwithstanding this usage of the term MSFOA herein, it is recognized herein that the term MSFOA could also be defined in a broader manner encompassing one or more of the performing of non-proprietary algorithms such as consistent hashing and/or time-based determinations utilizing TTL value information. That is, the term MSFOA could alternately be defined more generally to encompass the performing of a wider array of algorithms, including non-proprietary algorithms such as consistent-hashing and/or methods relying upon times such as TTLs associated with various data items. If such an interpretation was ascribed to the term MSFOA, then it would be further proper to distinguish between non-TTL-based, proprietary MSFOAs, and other types of MSFOAs (e.g., methods employing “vanilla” consistent hashing). Also, if viewed in this manner, the term MSFOA could then be viewed as a general plug-able framework, on which any specialized MSFOA methods could be accordingly plugged in to solve any specific problem.

Further, although the above description is concentrated upon embodiments involving memcached systems with memcached servers or server nodes, it should be appreciated that other embodiments are intended to be encompassed herein in which one or more of the memory storage and/or retrieval process features and/or one or more of the system features (e.g., a proxy device) described herein are employed, even though such other embodiments are not specifically directed toward cache memory systems or memcached systems. Also, while the memcached system 102 of FIG. 1 and much of the description above envisions systems and methods of operation in which the memcached devices of a cluster are in communication with a proxy module or device in two respects, namely (1) for the purpose of storing and/or retrieving information, and (2) for the purpose of monitoring the health or status of the memcached devices, both of these functions need not be present in other embodiments. In particular, in some embodiments, the monitoring function (2) need not be performed. In some such embodiments in which the monitoring function is not performed, other actions or events involving memcached operation can provide indirect indications of the status of one or more of the memcached devices. For example, a direct data access failure (and signals indicative thereof) as discussed with respect to FIG. 4 can already mark a destination memcache server node as being inoperative or “down”.

Embodiments such as those described above are advantageous in numerous respects. For example, the above-described protocol of operation is capable of providing a consistent and reliable view of data being stored in memcached and/or a consistent locking functionality on top of the memcached. At least some of the above-described embodiments can be employed to provide a course grained locking service. However depending upon the embodiment such devices and processes can be used for any arbitrary data that needs to be viewed consistently. Also, embodiments such as these are scalable and can utilize existing infrastructure, leverage the efficiency and stability of memcached, and avoid excessive complexity or inconsistency. Further for example, the systems discussed above, as all in memory systems, are relatively fault tolerant, and inexpensive to maintain. Also, the systems are relatively fast (as single-operation), and can be or not be disk dependent. Also, the systems allow for relatively fine grain locking Finally, the systems discussed above are expandable, particularly in that the systems solve issues in memcached centered on adding servers to the consistent hash ring. The memcached architecture handles the loss of a server gracefully.

Although the present disclosure is intended to encompass a variety of embodiments, it is intended that at least some of these embodiments include the following. In some embodiments, for example, a system for storing or retrieving data in response to one or more signals provided from one or more client computer devices includes a plurality of memcached-type memory devices arranged in a cluster, and a proxy module configured to communicate at least indirectly with each of the memcached-type memory devices and further configured to receive the one or more signals. The proxy module includes a memory portion that stores information regarding a status of each of the memcached-type memory devices, particularly in terms of whether each of the memcached-type memory device is in an active state, an inactive state, or a transitional state between the active and inactive states. Also, the proxy module and memcached-type memory devices communicate on an ongoing basis so that the information regarding the status of each of the memcached-type memory devices that is stored in the memory portion is repeatedly updated, and the proxy module determines how to proceed in communicating with the memcached-type memory devices for the purpose of the storing or retrieving of the data based at least in part upon the information stored in the memory portion.

In at least one such embodiment, the above-described system is such that the proxy module includes a consistent-hashing module that performs a consistent-hashing process, and wherein the proxy module makes at least an initial determination of which of the memcached-type memory devices should be contacted in relation to a first one of the signals of the one or more signals based upon a consistent-hashing value associated with a first data item key. Also, in at least one additional embodiment, the above-described system is such that a first one of the signals received by the proxy module includes a time-to-live (TTL) value corresponding to a data item communicated or identified by the first signal. Further, in at least one additional embodiment, the above-described system is such that the proxy module performs a determination whether a value representative of a difference between a current time and an active-since time for a given one of the memcached-type devices is greater than the TTL value and, based upon the determination, further determines whether an attempt to access the given one of memcached-type devices should be made or whether the given one of the memcached-type devices should be considered to be in the transitional state. Additionally, in at least one further embodiment, prior to the performing of the determination, the proxy module also determines whether the given one of the memcached-type devices is in the inactive state, and/or the proxy module causes accessing of the given one of the memcached-type devices if the attempt is made and the accessing is successful or, if not, the proxy module stores in the memory portion that the given one of the memcached-type devices is in the inactive state and further sends a failure notification.

Further, in at least one additional embodiment, the above-described system further includes a microprocessor on which is implemented the proxy module. Also, in at least one such embodiment, a consistent-hashing (or circular-hashing) module is also implemented by the microprocessor. Additionally, in at least one further embodiment, the above-described system further includes a first plurality of communication links by which the proxy module is in communication with the memcached-type memory devices so that the proxy module can obtain the information regarding status, and a second plurality of communication links by which the proxy module is in additional communication with the memcached-type memory devices so that the proxy module can cause the storing or retrieving of the data. Also, in at least one additional embodiment, the above-described system is such the plurality of memcached-type memory devices are distributed at a plurality of data centers.

Further, in at least some additional embodiments encompassed by the present disclosure, a method of handling a signal from a client computer system (in which the signal is indicative of a request pertaining to a data item that is included in or referenced by the signal, and the request concerns performing of an action in relation to a memory system including a plurality of memcached-type memory devices) includes receiving the signal at a proxy module and determining an initial one of the memcached-type memory devices that should be contacted in relation to the request indicated by the signal based upon a circular-hashing process. The method also includes consulting a memory portion associated with the proxy module to obtain a status indication concerning the initial one of the memcached-type memory devices or another one of the memcached-type memory devices. If the status indication does not indicate an inactive state, then performing at least one additional determination as to whether the initial one or the other one of the memcached-type memory devices is appropriate for accessing and, if so, causing the performing of the action in relation to the initial one or the other one of the memcached-type memory devices so as to satisfy the request.

Also, in at least one additional embodiment, the above-described method further includes, if the status indication indicates that the initial one of the memcached-type memory devices is inactive, then considering accessing of the other one of the memcached-type memory devices. Additionally, in at least one such embodiment, the considering includes (a) determining whether each of the plurality of the memcached-type memory devices has been determined to be inactive and, if not, (b) determining that the other one of the memcached-type memory devices is successive one of the memcached-type memory devices in a ring-type order. Also, in at least one such embodiment, the method is such that the consistent-hashing process in particular determines the initial one of the memcached-type memory device based upon a key associated with the data item included or referenced by the signal.

Further, in at least one additional embodiment, the request includes one of a first request that the data item be stored, a second request that the data item be retrieved, a third request that the data item be updated, and a fourth request that the data item be removed from one or more of the memcached-type memory devices. Also, in at least one additional embodiment, the additional determination concerns whether a value representative of a difference between a current time and an active-since time for the initial one or the other one of the memcached-type devices is greater than a time-to-live (TTL) value associated with the data item. Also, in at least one such embodiment, the additional determination further includes attempting to access the initial one or the other one of the memcached-type devices and considering whether the attempted access is successful; and/or, if the difference is not greater than the TTL value, then the initial one or other one of the memcached-type devices is considered to be in a transitional state. Additionally, in at least one further embodiment, the method is such that the proxy module is repeatedly in communication with each of the plurality of the memcached-type devices to determine the status indication and additional status indications of each of the plurality of the memcached-type devices substantially concurrently with the performing of the receiving, the determining, the consulting, and the at least one additional determination.

Further, in at least some embodiment, the present disclosure includes a method of operating a memory system including a plurality of memcached-type memory devices to respond to signals from clients indicative of requests to be performed in relation to data item. The method includes providing a proxy module, and sending communications from the proxy module for receipt by each of the respective memcached-type memory devices. The method also includes, based upon responses received from the memcached-type memory devices, storing status indications regarding statuses of each of the memcached-type memory devices in a memory portion associated with the proxy module. Further, the method includes receiving the signals at the proxy module, and determining actions to be performed by the proxy module in relation to one or more of the memcached-type memory devices, the actions being determined based at least in part upon the requests, the stored status indications, and time-to-live (TTL) values associated with the data items with respect to which the requests pertain. Also, the method includes performing the actions in accordance with the determining, where the actions involve one or more of: reading one or more of the data items from one or more of the memcached-type memory devices; writing one or more of the data items to one or more of the memcached-type memory devices; causing an updating of one or more of the data items stored in one or more of the memcached-type memory devices; and causing a removal of one or more of the data items from one or more of the memcached-type memory devices.

Additionally, in at least some embodiments, a system for storing or retrieving data in response to one or more signals provided from one or more client computer devices includes a plurality of memcached-type memory devices arranged in a cluster, and a proxy module configured to communicate at least indirectly with each of the memcached-type memory devices and further configured to receive the one or more signals. The proxy module is configured to perform a determination of how to proceed in communicating with the memcached-type memory devices for the purpose of the storing or retrieving of data at or from one or more of the memcached-type memory devices in response to the one or more signals.

Further, in at least some such embodiments, the proxy module includes a memcache selection/fail-over algorithm (MSFOA) module that is configured to perform a MSFOA, and the proxy module makes at least an initial determination of which of the memcached-type memory devices should be contacted in relation to a first one of the signals of the one or more signals based upon a determination obtained via a performing of the MSFOA, the determination being associated with a first data item key. Also, in at least some such embodiments, the proxy module includes a consistent-hashing module, and the proxy module makes at least the initial or a further determination of which of the memcached-type memory devices should be contacted based upon both the performing of the MSFOA and a consistent-hashing value associated with the first data item key. Additionally, in at least some such embodiments, the proxy module is configured to perform the MSFOA repeatedly in response to at least two of the one or more signals received from at least two of the one or more client computer devices, where a first of the signals concerns the storing of the data and a second of the signals concerns the retrieving of the data.

Also, in at least some embodiments, a method of handling a signal from a client computer system (where the signal is indicative of a request pertaining to a data item that is included in or referenced by the signal, and the request concerns performing of an action in relation to a memory system including a plurality of memcached-type memory devices) includes receiving the signal at a proxy module, and determining an initial one of the memcached-type memory devices that should be contacted in relation to the request indicated by the signal based at least in part upon one or both of a circular-hashing process and a memcache selection/fail-over algorithm (MSFOA) operation. The method further includes engaging in at least one communication with the initial one of the memcached-type memory devices in order to store, retrieve, or attempt to retrieve the data item to or from the initial one of the memcached-type memory devices, in order to take an action responsive to the request. In at least some such embodiments, the at least one of the consistent-hashing process and MSFOA operation determines the initial one of the memcached-type memory device based upon a key associated with the data item included or referenced by the signal. Further, in at least some such embodiments, the method includes detecting a failure of the attempt to retrieve the data item, determining an additional one of the memcached-type memory devices that should be contacted in relation to the request indicated by the signal based at least in part upon an additional memcache selection/fail-over algorithm (MSFOA) operation, and engaging in at least one further communication with the additional one of the memcached-type memory devices in order to attempt to retrieve the data item from the additional one of the memcached-type memory devices.

Further, in at least some embodiments, a method of operating a memory system (where the memory system includes a plurality of memcached-type memory devices to respond to signals from clients indicative of requests to be performed in relation to data items) includes providing a proxy module, receiving the signals at the proxy module, and determining actions to be performed by the proxy module in relation to one or more of the memcached-type memory devices, the actions being determined based at least in part upon the requests. The method also includes performing the actions in accordance with the determining, where the actions involve one or more of: reading or attempting reading of one or more of the data items from one or more of the memcached-type memory devices; writing one or more of the data items to one or more of the memcached-type memory devices; causing an updating of one or more of the data items stored in one or more of the memcached-type memory devices; and causing a removal of one or more of the data items from one or more of the memcached-type memory devices.

Also, in at least some such embodiments, the determining of the actions includes performing a plurality of memcache selection/fail-over algorithm (MSFOA) operations, where a first of the actions includes the writing of the first data item to a first of the memcached-type memory devices that is selected from among the plurality of memcached-type memory devices based at least in part upon the performing of a first of the MSFOA operations, where a second of the actions includes the attempted reading of the first data item from the first of the memcached-type memory devices that is selected from among the plurality of memcached-type memory devices based at least in part upon the performing of a second of the MSFOA operations, and where the first action is performed in response to the receiving of the first signal and the second action is performed in response to the receiving of the second signal. Further, in at least some such embodiments, the method includes detecting a failure of the attempted reading. Upon the detecting of the failure, a third of the actions is performed, wherein the third of the actions includes either (a) sending a signal for receipt by the second client that is indicative of an access error, or (b) an additional attempted reading of the first data item from a second of the memcached-type memory devices that is selected from among the plurality of memcached-type memory devices based at least in part upon the performing of a third of the MSFOA operations.

Thus, it is specifically intended that the present invention not be limited to the embodiments and illustrations contained herein, but include modified forms of those embodiments including portions of the embodiments and combinations of elements of different embodiments as come within the scope of the following claims.

1. A system for storing or retrieving data in response to one or more signals provided from one or more client computer devices, the system comprising:
a plurality of memcached-type memory devices arranged in a cluster; and
a proxy module configured to communicate at least indirectly with each of the memcached-type memory devices and further configured to receive the one or more signals,
wherein the proxy module is configured to perform a determination of how to proceed in communicating with the memcached-type memory devices for the purpose of the storing or retrieving of data at or from one or more of the memcached-type memory devices in response to the one or more signals.

2. The system of claim 1, wherein the proxy module includes a memory portion.

3. The system of claim 1, wherein the proxy module includes a consistent-hashing module that performs a consistent-hashing process.

4. The system of claim 3, wherein the proxy module makes at least an initial determination of which of the memcached-type memory devices should be contacted in relation to a first one of the signals of the one or more signals based upon a consistent-hashing value associated with a first data item key.

5. The system of claim 1 wherein, prior to a performing of the determination, the proxy module also determines whether a given one of the memcached-type devices is in the inactive state.

6. The system of claim 1, further comprising a microprocessor on which is implemented the proxy module.

7. The system of claim 1, further comprising a first plurality of communication links by which the proxy module is in communication with the memcached-type memory devices so that the proxy module can cause the storing or retrieving of the data.

8. The system of claim 7, wherein the proxy module operates as a centralized proxy module, and wherein all communications between the one or more client computer devices and the one or more memcached-type memory devices occur by way of the centralized proxy module operating as an intermediary between the client computer devices and memcached-type memory devices.

9. The system of claim 1, wherein the plurality of memcached-type memory devices are distributed at a plurality of data centers.

10. A method of handling a signal from a client computer system, the signal being indicative of a request pertaining to a data item that is included in or referenced by the signal, the request concerning performing of an action in relation to a memory system including a plurality of memcached-type memory devices, the method comprising:
receiving the signal at a proxy module;
determining an initial one of the memcached-type memory devices that should be contacted in relation to the request indicated by the signal based at least in part upon a consistent-hashing process;
engaging in at least one communication with the initial one of the memcached-type memory devices in order to store, retrieve, or attempt to retrieve the data item to or from the initial one of the memcached-type memory devices, in order to take an action responsive to the request.

11. The method of claim 10, further comprising:
performing a determination that the initial one of the memcached-type memory devices is inactive, and
upon performing the determination, considering accessing of another one of the memcached-type memory devices.

12. The method of claim 11, wherein the considering includes (a) determining at the proxy module whether each of the plurality of the memcached-type memory devices has been determined to be inactive and, if not, (b) determining that the other one of the memcached-type memory devices is a successive one of the memcached-type memory devices in a ring-type order.

13. The method of claim 10, wherein the consistent-hashing process determines the initial one of the memcached-type memory device based upon a key associated with the data item included or referenced by the signal.

14. The method of claim 10, wherein the request includes one of a first request that the data item be stored, a second request that the data item be retrieved, a third request that the data item be updated, and a fourth request that the data item be removed from one or more of the memcached-type memory devices.

15. The method of claim 10, further comprising:
detecting a failure of the attempt to retrieve the data item; and
determining an additional one of the memcached-type memory devices that should be contacted in relation to the request indicated by the signal.

16. The method of claim 15, further comprising:
engaging in at least one further communication with the additional one of the memcached-type memory devices in order to attempt to retrieve the data item from the additional one of the memcached-type memory devices.

17. A method of operating a memory system including a plurality of memcached-type memory devices to respond to signals from clients indicative of requests to be performed in relation to data items, the method comprising:
providing a proxy module;
receiving the signals at the proxy module; and
determining actions to be performed by the proxy module in relation to one or more of the memcached-type memory devices, the actions being determined based at least in part upon the requests; and
performing the actions in accordance with the determining,
wherein the actions involve one or more of: reading or attempting reading of one or more of the data items from one or more of the memcached-type memory devices; writing one or more of the data items to one or more of the memcached-type memory devices; causing an updating of one or more of the data items stored in one or more of the memcached-type memory devices; and causing a removal of one or more of the data items from one or more of the memcached-type memory devices.

18. The method of claim 17, wherein a first of the signals is received from a first of the clients and is indicative of a first request to store a first of the data items, and a second of the signals is received from a second of the clients and is indicative of a second request to retrieve the first of the data items.

19. The method of claim 18, wherein the reading, attempting reading, writing, causing of the updating, and causing of the removal include sending one or more communications from the proxy module for receipt by at least one of the memcached-type memory devices.

20. The method of claim 17, wherein the plurality of memcached-type memory devices are distributed at a plurality of data centers.
